(19) United States
(12) Patent Application Publication
(10) Pub. No.: US 2006/0104305 A1
(43) Pub. Date: May 18, 2006

(54) Audio/video streaming system

(76) Inventors: William Yoshida, Westampton, NJ (US); Ramprasad Pothukanuri, Plainsboro, NJ (US)

Correspondence Address: MCDERMOTT WILL & EMERY LLP, 600 13TH STREET, N.W., WASHINGTON, DC, 20005-3096, US

(21) Appl. No.: 10/986,435

(22) Filed: Nov. 12, 2004

(51) Int. Cl. H04J 3/22

(52) U.S. Cl. 370/466

(57) ABSTRACT

A system for using a low-level packet protocol to accelerate content delivery in a non-routable network is provided. The system includes a transport stream processor for receiving a multiple program transport stream (e.g., in MPEG-2 format) and extracting a data program stream from the transport stream. The data program stream includes audio/video content in a second format (e.g., in MPEG-4 format). A packet generator packetizes the content in the data program stream for delivery over an Internet protocol (IP)-based local area network. Further features, such as quality of service management, are also provided.

### TECHNICAL FIELD

The present invention relates generally to delivery of audio/video bitstreams, and more particularly, to parsing a digital video bitstream for user-selectable content and generating a packet structure including the parsed content.

### BACKGROUND

In a typical framework for delivering digital video bitstreams to a consuming device, such as an audio/video display, the consuming device buffers the bitstream in order to ensure proper isochronous display of the data. One problem with such buffering, however, is that an embedded device (e.g., a set-top box or television) typically lacks the memory or processing resources needed to buffer the data. This problem is especially manifested when multiple bitstreams are presented to the embedded device concurrently. Multiple bitstreams may be needed to support features such as picture-in-picture, digital video recording, and the like.

Additionally, conventional digital video streaming systems use application-level protocols, such as real-time transport protocol (RTP) to manage the end-to-end delivery system across a routable network. The use of an application-level protocol requires the consuming or client device to include a corresponding protocol stack, which adds cost and complexity to an embedded solution.

What is needed is a streaming system that uses a low-level protocol to accelerate content delivery in a non-routable network.

### SUMMARY OF THE INVENTION

In one aspect, a stream processor includes a transport stream processor, a packet generator, and a network controller. The transport stream processor receives a digital video bitstream and filters the digital video bitstream. The packet generator is operatively coupled to the transport stream processor and generates a packetized stream from the filtered digital video bitstream. The network controller is operatively coupled to the packet generator and provides the packetized stream to the local area network.

In another aspect, a stream processor includes means for receiving a digital video bitstream and filtering the digital video bitstream, means for generating a packetized stream from the filtered digital video bitstream, and means for providing the packetized stream to the local area network.

In a further aspect, a method of processing a digital video bitstream includes receiving a transport bitstream. The method also includes filtering the transport bitstream by a predetermined program identifier to produce a video bitstream and filtering the video bitstream by at least one user-defined program identifier to produce a filtered bitstream. The filtered bitstream is then packetized to produce a packetized stream.

In another aspect, a method for consuming a packetized stream includes receiving, from a local area network interface, the packetized stream including a first data portion corresponding to a first digital video program stream and a second data portion corresponding to a second digital video program stream and parsing the packetized stream into first and second data portions. The first data portion is provided to a first decoder, and the second data portion is provided to a second decoder.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 illustrates a system diagram according to an embodiment of the present invention.

FIG. 2 illustrates a stream processor according to an embodiment of the present invention.

FIG. 3 illustrates a transport stream processor according to an embodiment of the present invention.

FIG. 4 illustrates an exemplary packet structure for use in an embodiment of the present invention.

FIG. 5 illustrates a method for processing a digital video bitstream according to an embodiment of the present invention.

### DETAILED DESCRIPTION OF THE EMBODIMENTS

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be thorough and complete and will fully convey the invention to those skilled in the art. Although functional entities may be illustrated in distinct functional blocks, one skilled in the art will appreciate that the functionality described herein may be implemented in more or fewer functional blocks than those specifically illustrated herein.

A. System Overview

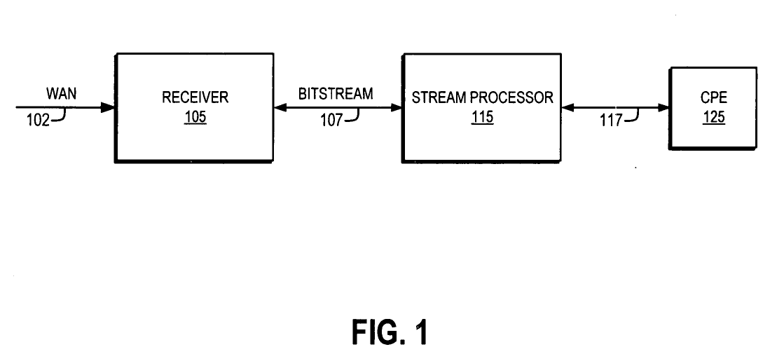

FIG. 1 illustrates a system diagram according to an embodiment of the present invention. The illustrated embodiment includes a receiver 105, a stream processor 110, and a customer premises equipment (CPE) 125. The receiver 105 receives content via a wide area network 102. The wide area network 102 represents any network that is suitable for transporting digital video, such as satellite or terrestrial broadcast, cable, or data networks.

The receiver 105 provides the digital video bitstream to the stream processor 115 via communications path 107 (e.g., an asynchronous serial interface). In certain embodiments, the receiver 105 provides an MPEG-2 transport stream that includes a plurality of programs to the stream processor 115. More specifically, the receiver 105 provides a conventional MPEG-2 multi-program transport stream (MPTS) to the stream processor 115. One or more of the programs within the MPTS include video content that is transported as arbitrary data. In certain embodiments, the video content represents one or more MPEG-4 compressed digital video streams.

The stream processor 115 receives the MPTS and performs filtering on the bitstream. The filtering is user-defined or user-configurable. That is, the user of the CPE 125 can select one or more program streams to be filtered. The stream processor 115 receives commands from the CPE 117 via the local area network (LAN) 117. The stream processor 115 then extracts or filters the selected streams and packetized the streams for transport on the LAN 117. In certain embodiments, the local area network is an Ethernet-based LAN. As one skilled in the art will appreciate, the LAN 117 may also represent other network types or topologies, including a cable radio frequency (RF) data network. The stream processor 115 packetizes the selected streams such that the CPE 125 need not include a full protocol stack to decode the streams. As described further below, the stream processor 115 places the one or more program streams into an Ethernet frame with little header information. One advantage of this structure is that the CPE 125 need not process the Ethernet frame payload through multiple network stack layers. In certain embodiments, the Ethernet frame payload can be processed by the CPE 125 at layer 2 with little buffering or overhead. As one skilled in the art will appreciate, the selected streams may be provided directly to video decoder hardware/software for display, storage, and the like.

The CPE 125 may be a display device, such as a television monitor. In the illustrated embodiment, the CPE 125 includes a conventional network interface (e.g., Ethernet interface) for coupling with the LAN 117.

B. Stream Processing

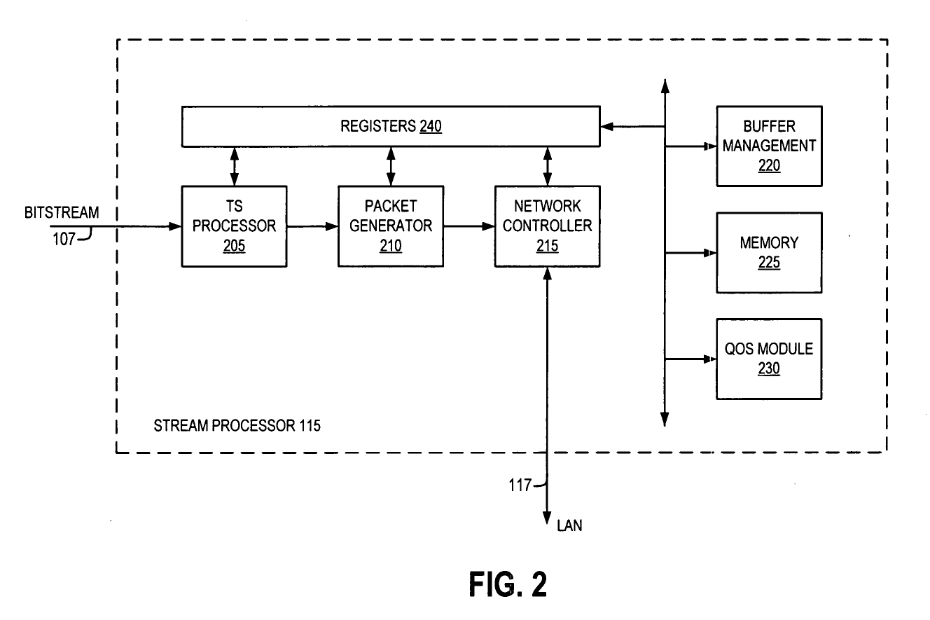

FIG. 2 illustrates the stream processor 115 in further detail. The illustrated embodiment includes a transport stream (TS) processor 205, a packet generator 210, a network controller 215, a buffer management module 220, a memory 225, a quality of service (QOS) module 230, and registers 240.

The TS processor 205 receives the bitstream from communications path 107 and filters the bitstream by one or more program identifiers (PIDs). A PID is a conventional technique in an MPEG-2 transport stream to differential among the multiple programs that are multiplexed in the transport stream. In certain embodiments, one or more of the programs is a data program that includes MPEG-4 content. That is, the MPEG-2 payload encapsulates conventional MPEG-4 content. The MPEG-4 content may be configured to fit within the MPEG-2 payload with or without padding/segmentation (i.e., splitting a single MPEG-4 packet into multiple MPEG-2 payloads).

The TS processor 205 provides the filtered digital video bitstream as output to the packet generator 210. The packet generator 210 packetizes the one or more streams to generate a packetized stream. The packetized stream can include a header that is suitable for transport on a LAN. Typically, the packetized stream includes non-routable source/destination addresses (i.e., private addresses), which enables a plurality of local CPE devices to consume the content and communicate control commands to the stream processor 115.

The network controller 215 represents a conventional network interface, such as an Ethernet interface. In the illustrated embodiment, the network controller 215 provides the packetized stream to the LAN 117 and operates in conjunction with the buffer management module 220, the memory 225, and the QOS module 230 to ensure isochronous delivery of the packetized stream. For example, the QOS module 230 can implement layer 2 quality of service features to ensure sufficient bandwidth allocation and packet arrivals at the CPE 125. Because the CPE 125 typically lacks memory to buffer the arriving video content, the memory 225 may be used to buffer packets before they are sent to the CPE 125.

The registers 240 include predetermined as well as user-defined configuration information. The registers 240 communicate configuration information to other functional entities. For example, the PID at which the MPEG-4 content is transported within the MPEG-2 transport stream may be predetermined by a system configuration setting. On the other hand, the PIDs of the MPEG-4 content may be user-defined in various ways. For example, the CPE 125 may communicate PID selection information to the registers 240 to cause program stream changes (e.g., channel changes).

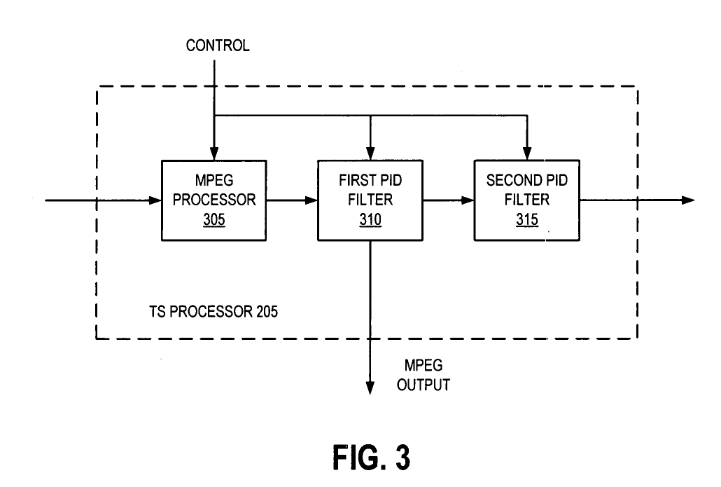

FIG. 3 illustrates a transport stream processor according to an embodiment of the present invention. The illustrated embodiment includes an MPEG processor 305, a first program identifier (PID) filter 310, and a second PID filter 315. Each of the MPEG processor 305 and the first and second PID filters 310, 315 are communicatively coupled to control signals, which are provided by the registers 240. The MPEG process 305 receives a MPTS bitstream and decodes the bitstream into one or more packetized elementary streams. The packetized elementary streams are then processed by the first PID filter 310, which segregates the MPTS. The first PID filter extracts the data for the program channel that is carrying the MPEG-4 content. The remaining program streams are provided to an MPEG output. The second PID filter 315 parses the MPEG-4 content based on user-defined PID information and provides the parsed content as an output.

C. Packet Structure

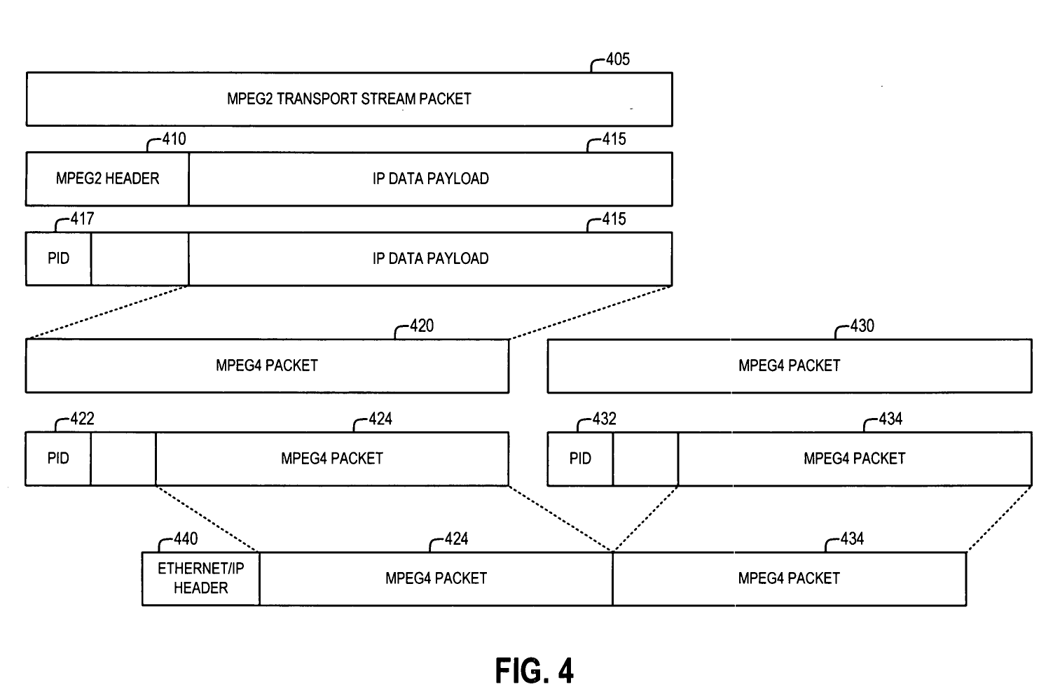

FIG. 4 illustrates an exemplary packet structure for use in an embodiment of the present invention. In the illustrated example, an MPEG-2 transport stream packet 405 is shown. The MPEG-2 transport stream packet 405 includes an MPEG-2 header 410 and an Internet protocol (IP) data payload 415. The MPEG-2 header 410 can be further divided into fields, such as the PID 417. The IP data payload 415 portion of the MPEG-2 transport stream packet 405 includes one or more MPEG-4 packets 420, 430.

In the illustrated example, the first MPEG-4 packet 420 represents audio/video content from a first program and the second MPEG-4 packet 430 represents audio/video content from a second program. The MPEG-4 packets also include header information. The header information can be divided into fields, such as PIDs 422, 432. The MPEG-4 packet payload portions 424, 434 are marshaled into an IP packet for transport to the CPE 125.

The IP packet includes an Ethernet/IP header 440, which is typically non-routable outside of a local area network. The IP packet also includes the MPEG-4 packet payload portions 424, 434 as data payload to be transported to one or more CPE devices, such as display devices.

D. Method

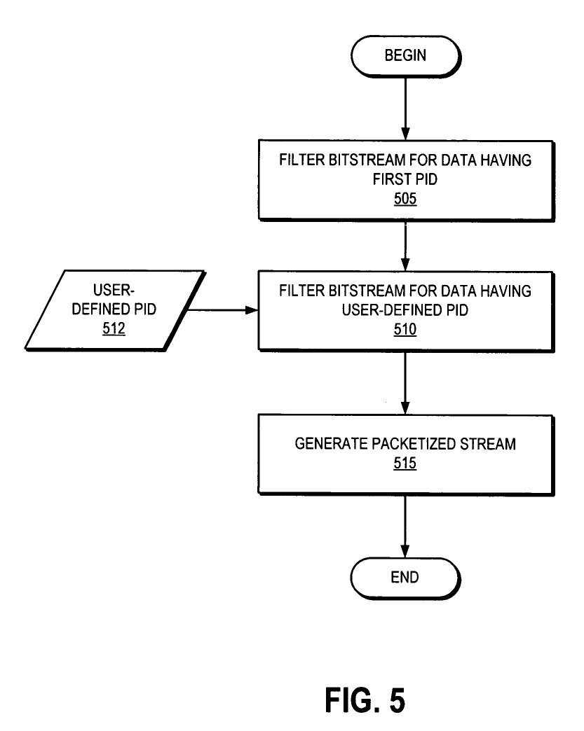

FIG. 5 illustrates a method for processing a digital video bitstream according to an embodiment of the present invention. The illustrated embodiment begins with filtering 505 a bitstream for data having a first PID. The first PID corresponds with the PID of the data transport program that includes MPEG-4 or other audio/video content in another format. The bitstream is then filtered 510 for data having one or more user-defined PIDs 512 to generate MPEG-4 content streams. The MPEG-4 content streams are packetized 515 and delivered to one or more CPE devices via a local area network. The packetized stream can include quality of service features, such as packet prioritization using conventional differentiated services (DiffServ).

Having described embodiments of audio/video streaming system (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims and equivalents.

What is claimed is:

1. A stream processor comprising:
a transport stream processor configured to receive a digital video bitstream and to filter the digital video bitstream;
a packet generator operatively coupled to the transport stream processor and configured to generate a packetized stream from the filtered digital video bitstream; and
a network controller operatively coupled to the packet generator and configured to provide the packetized stream to a local area network.

2. The stream processor of claim 1, wherein the packet generator is further configured to extract MPEG-4 content from a data payload portion of a packet of the digital video bitstream.

3. The stream processor of claim 1, wherein the transport stream processor comprises:
a first program identifier filter configured to parse a first data payload from the digital video bitstream.

4. The stream processor of claim 3, wherein the transport stream processor further comprises:
a second program identifier filter configured to parse a second data payload from the first data payload.

5. The stream processor of claim 4, wherein the first data payload comprises digital video associated with a first program and the second data payload comprises digital video associated with a second program.

6. The stream processor of claim 1, wherein the digital video bitstream comprises an MPEG-2 transport stream.

7. The stream processor of claim 1, wherein the packetized stream comprises an Ethernet header and MPEG-4 content.

8. The stream processor of claim 7, wherein the packetized stream includes digital video associated with at least a first program and a second program.

9. The stream processor of claim 1, further comprising:
a quality of service module operatively coupled to the network controller and configured to provide at least one of bandwidth and jitter management.

10. A stream processor comprising:
means for receiving a digital video bitstream and filtering the digital video bitstream;
means for generating a packetized stream from the filtered digital video bitstream; and
means for providing the packetized stream to a local area network.

11. A method of processing a digital video bitstream, the method comprising:
receiving a transport bitstream;
filtering the transport bitstream by a predetermined program identifier to produce a video bitstream;
filtering the video bitstream by at least one user-defined program identifier to produce a filtered bitstream; and
packetizing the filtered bitstream to produce a packetized stream.

12. The method of claim 11, further comprising:
inserting header information into the packetized stream; and
providing packetized stream to a local area network.

13. The method of claim 11, wherein the transport bitstream comprises an MPEG-2 digital video bitstream.

14. The method of claim 11, wherein the predetermined program identifier corresponds to a data payload stream.

15. The method of claim 11, wherein the at least one user-defined program identifier corresponds to at least one MPEG-4 content stream.

16. A method for consuming a packetized stream including header information, the method comprising:
receiving, from a local area network interface, the packetized stream including a first data portion corresponding to a first digital video program stream and a second data portion corresponding to a second digital video program stream;
parsing the packetized stream into first and second data portions;
providing the first data portion to a first decoder; and
providing the second data portion to a second decoder.

17. The method of claim 16, wherein the first and second data portions each comprise 746 octets in size.

18. The method of claim 16, wherein at least one of the first and second decoders provides the corresponding video program stream to a display device.

19. The method of claim 16, wherein at least one of the first and second decoders provides the corresponding video program stream to a storage device.
